(19) United States
(12) Patent Application Publication
(10) Pub. No.: US 2026/0319456 A1
(43) Pub. Date: Oct. 15, 2026

(54) NUMERICAL CONTROL DEVICE AND MACHINE TOOL

(71) Applicant: FANUC CORPORATION, Yamanashi (JP)

(72) Inventors: Takatoshi NARISAWA, Yamanashi (JP); Dongseok KIM, Yamanashi (JP); Yasusuke IWASHITA, Yamanashi (JP)

(73) Assignee: FANUC CORPORATION, Yamanashi (JP)

(21) Appl. No.: 19/101,396

(22) PCT Filed: Oct. 11, 2022
(86) PCT No.: PCT/JP2022/037859

§ 371 Date: Feb. 5, 2025

(51) Int. Cl. G05B 19/4093

(52) U.S. Cl. CPC G05B 19/40932; G05B 2219/50291

(57) ABSTRACT

A numerical control device according to one aspect of the present disclosure, which can form a two-dimensional code in a relatively short time, controls a processing mechanism that processes a workpiece by means of a plurality of tools, the numerical control device comprising: a configuration information storage unit which stores machine configuration information including information about the tools of the processing mechanism; a code data acquisition unit which acquires code data that identifies the shape of one or a plurality of two-dimensional codes to be formed on the surface of the workpiece; a concurrent process generation unit which generates a plurality of concurrent processes that are allocated to all valid tools one-by-one on the basis of the code data and the machine configuration information and cause all the valid tools to cooperate so that all the two-dimensional codes are formed by being concurrently executed; and a concurrent process execution unit which executes the plurality of concurrent processes.

### TECHNICAL FIELD

The present invention relates to a numerical control device and a machine tool.

### BACKGROUND ART

Machine tools that form a two-dimensional code on an object to be machined (workpiece) by milling are known.

### CITATION LIST

### Patent Document

Patent Document 1: Japanese Unexamined Patent Application, Publication No. 2016-201075

### DISCLOSURE OF THE INVENTION

### Problems to be Solved by the Invention

Two-dimensional codes are complicated and can be difficult to read if they are not accurately formed. Thus, a relatively long time is required to form a two-dimensional code by machining.

### Means for Solving the Problems

A numerical control device according to one aspect of the present disclosure controls a machining mechanism for machining a workpiece by using a plurality of tools, the numerical control device including: a configuration information storage unit that stores machine configuration information including information on the tools of the machining mechanism; a code data acquisition unit that acquires code data for identifying the shape of one or more two-dimensional codes to be formed on the surface of the workpiece; a parallel process generation unit that generates a plurality of parallel processes the basis of the code data and the machine configuration information, the plurality of parallel processes being allocated to all of valid one or more of the plurality of tools on a one-to-one basis, and being executed in parallel so as to cooperatively operate all of the valid one or more of the plurality of tools such that all of the two-dimensional codes are formed; and a parallel process execution unit that executes the parallel processes.

A numerical control device according to another aspect of the present disclosure controls a machining mechanism for machining a workpiece by using a tool, the numerical control device including: a configuration information storage unit that stores machine configuration information including information on the tool of the machining mechanism; a code data acquisition unit that acquires code data for identifying the shape of a plurality of two-dimensional codes to be formed on the surface of the workpiece; a parallel process generation unit that generates a parallel process on the basis of the code data and the machine configuration information, the parallel process being for operating the tool such that all of the two-dimensional codes are formed in parallel; and a parallel process execution unit that executes the parallel process.

A numerical control device according to still another aspect of the present disclosure controls a machining mechanism for machining a workpiece by using one or a plurality of tools, the numerical control device including: a configuration information storage unit that stores machine configuration information including information on the tools of the machining mechanism; a code data acquisition unit that acquires code data for identifying the shape of one or more two-dimensional codes to be formed on the surface of the workpiece; an integrated-data generation unit that generates integrated data for identifying the shape of a single integrated pattern including all of the two-dimensional codes; and a parallel process generation unit that generates a plurality of parallel processes on the basis of the integrated data and the machine configuration information, the plurality of parallel processes being allocated to all of valid one or more of the one or plurality of tools on a one-to-one basis, and being executed in parallel so as to cooperatively operate all of the valid one or more of the one or plurality of tools such that all of the two-dimensional codes are formed; and a parallel process execution unit that executes the parallel processes.

### Effects of the Invention

According to the present disclosure, a two-dimensional code can be formed in a relatively short time.

### BRIEF DESCRIPTION OF THE DRAWINGS

FIG. 1 is a schematic diagram illustrating the configuration of a machine tool according to one embodiment of the present disclosure;

FIG. 2 is a perspective view exemplifying a workpiece machined by the machine tool in FIG. 1;

FIG. 3 is a developed view of the workpiece in FIG. 2;

FIG. 4 is a schematic diagram illustrating the shape of two-dimensional codes formed on a workpiece by the machine tool in FIG. 1;

FIG. 5 is a schematic diagram illustrating an example of tool paths of the machine tool in FIG. 1;

FIG. 6 is a schematic diagram illustrating an example of tool paths of the machine tool in FIG. 1, the example differing from that in FIG. 5;

FIG. 7 is a flowchart illustrating a procedure for forming two-dimensional codes on a workpiece by using the machine tool in FIG. 1; and

FIG. 8 is a schematic diagram illustrating an example of tool paths according to a variation of the present disclosure.

### PREFERRED MODE FOR CARRYING OUT THE INVENTION

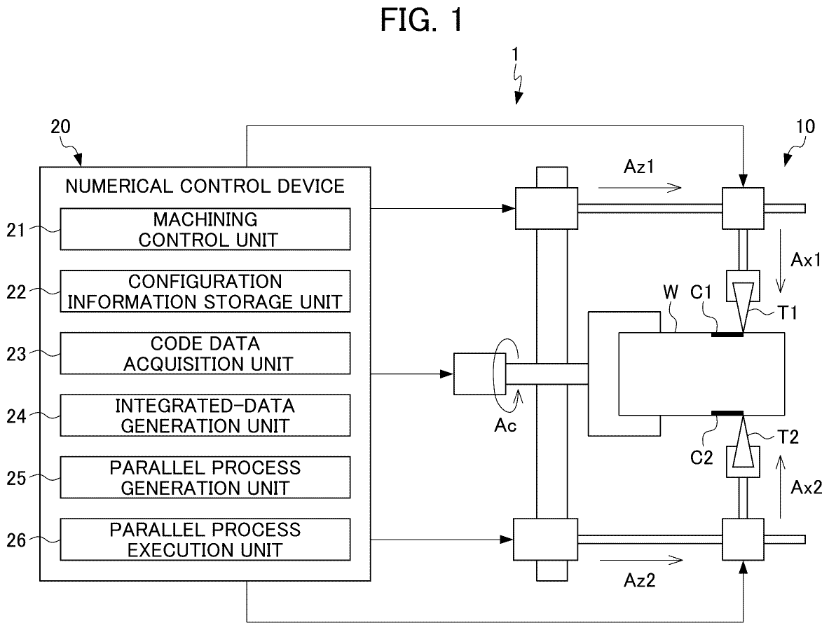

The following describes embodiments of the present disclosure by referring to the drawings. FIG. 1 is a schematic diagram illustrating the configuration of a machine tool 1 according to one embodiment of the present disclosure.

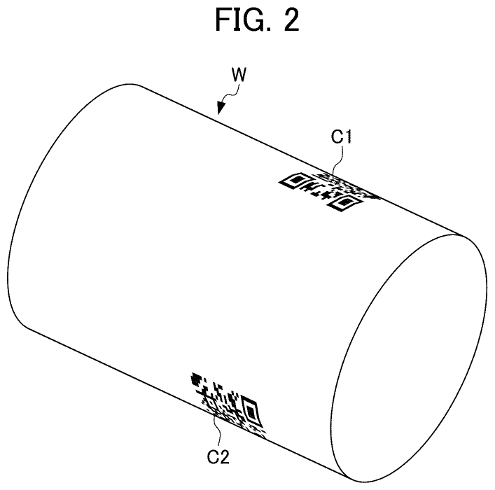

The machine tool 1 machines a workpiece W by using one or more tools (with reference to the figure, first tool T1 and second tool T2) and, as depicted in FIG. 2, forms one or more two-dimensional codes (with reference to the figure, first two-dimensional code C1 and second two-dimensional code C2) on the surface of the workpiece W by cutting. In particular, the two-dimensional codes C1 and C2 are formed as uneven patterns represented according to the presence/absence of cutting. The machine tool 1 includes a machining mechanism 10 that move the tools T1 and T2 and the workpiece W relative to each other, and a numerical control device 20 that controls the machining mechanism 10.

Although the configuration of the machining mechanism 10 is not particularly limited, a lathe is indicated as the machining mechanism 10 in depicted embodiments. The machining mechanism 10 according to present embodiments is provided with a plurality of drive shafts for moving the tools T1 and T2 and the workpiece W relative to each other. Specifically, the drive shafts include a main shaft Ac for rotating the workpiece W, a first feed shaft Az1 and a first cut shaft Ax1 for moving the first tool T1, and a second feed shaft Az2 and a second cut shaft Ax2 for moving the second tool T2. Although the machining mechanism 10 according to present embodiments are intended to machine the workpiece W by using the two tools T1 and T2, the number of tools to be used is not particularly limited.

The numerical control device 20 includes, for example, a memory, a processor, a storage device, and an input-output interface and may be implemented by one or more computer devices that execute an appropriate control program. The numerical control device 20 includes a machining control unit 21, a configuration information storage unit 22, a code data acquisition unit 23, an integrated-data generation unit 24, a parallel process generation unit 25, and a parallel process execution unit 26. Note that these components are obtained by categorizing functions of the numerical control device 20, and do not need to be clearly classified in terms of physical configuration and program configuration.

In accordance with a machining program described using, for example, G-code, the machining control unit 21 controls a machining operation performed on the workpiece W by the machining mechanism 10. The machining control unit 21 may be configured similarly to those in well-known numerical control devices.

The configuration information storage unit 22 stores machine configuration information including information on the tools T1 and T2 of the machining mechanism 10. The machine configuration information preferably includes the number of valid tools T1 and T2. Assuming that the user mounts, on the machining mechanism 10, tools T1 and T2 that may be used to machine two dimensional codes C1 and C2, the number of valid tools T1 and T2 may be the largest number (constant number) of tools T1 and T2 that the machining mechanism 10 can use, said largest number being determined on the basis of the machine configuration of the machining mechanism 10. Alternately, the number of valid tools T1 and T2 may be a variable number that is the number of tools T1 and T2 that the user actually mounted on the machining mechanism 10. Meanwhile, the machine configuration information preferably further includes, for example, the range of movement of each drive shaft, and the starting position, maximum speed, maximum acceleration, and maximum jerk of each drive shaft.

The code data acquisition unit 23 acquires code data for identifying the shape of one or more two-dimensional codes C1 and C2 to be formed on the surface of the workpiece W. The code data acquisition unit 23 may be configured to acquire code data from, for example, a storage device or an external server (not shown), or may be configured to generate code data from text data.

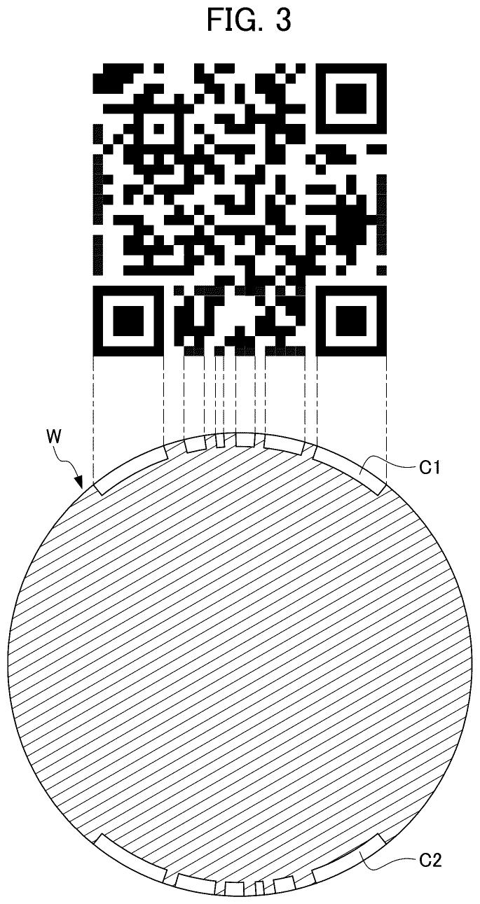

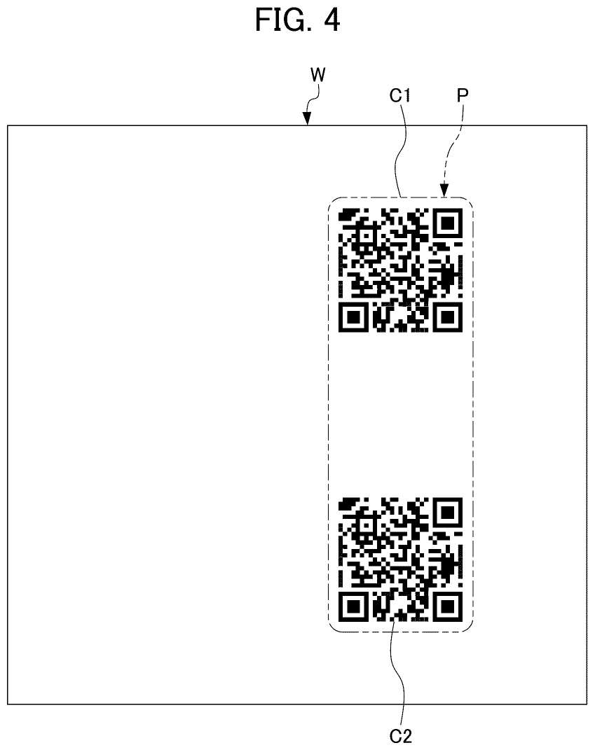

The integrated-data generation unit 24 generates integrated data for identifying the shape of a single integrated pattern P including all the two-dimensional codes C1 and C2 to be formed on the surface of the workpiece W. FIG. 4 is a developed view of the peripheral surface of the workpiece W, the developed view exemplifying the integrated pattern P. Note that the two-dimensional codes C1 and C2 included in the integrated pattern P do not need to be the same in shape. The integrated data is preferably three-dimensional data in which all the two-dimensional codes C1 and C2 are disposed on the surface of the workpiece W. In the integrated data, the shape of the two-dimensional codes C1 and C2 is preferably one assumed when, as indicated in FIG. 3, planar two-dimensional codes C1 and C2 are projected onto the surface of the workpiece W in the radial direction of the workpiece W, such that the two-dimensional codes C1 and C2 are not distorted when the workpiece W is observed. The depth of the cut portions of the two-dimensional codes C1 and C2 is preferably constant.

The parallel process generation unit 25 generates a plurality of parallel processes on the basis of integrated data and machine configuration information, the plurality of parallel processes being allocated to all of the valid tools T1 and T2 on a one-to-one basis and being executed in parallel so as to cooperatively operate all of the valid tools T1 and T2 such that all of the two-dimensional codes C1 and C2 are formed. The “parallel processes” mean a series of operations including not only the operation of causing the tools T1 and T2 to act on the workpiece W but also the operation of moving the tools T1 and T2 for said operation of causing. These parallel processes are executed at least partially concurrently with other parallel processes. The plurality of parallel processes do not need to be represented as separate pieces of information, and may be represented as, for example, a single data file including a plurality of words for identifying an operation for each of the tools T1 and T2.

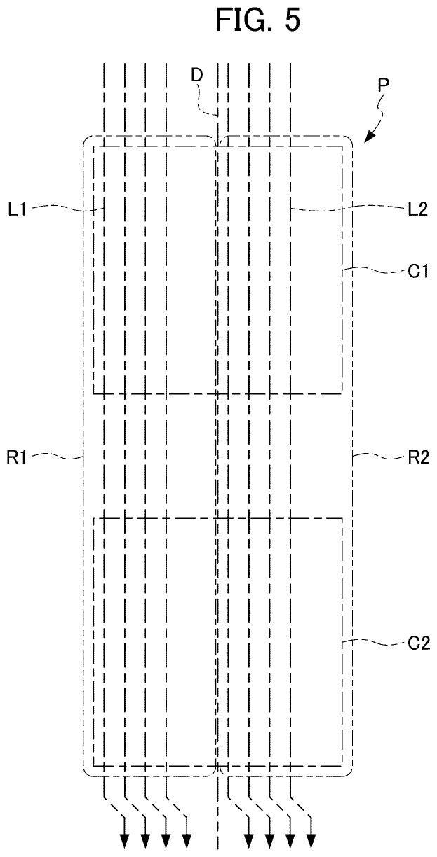

As depicted in FIG. 5, the parallel process generation unit 25 may segment the integrated pattern P into a plurality of segment regions R1 and R2 having an equal width in the feed direction of the tools T1 and T2, and generate parallel processes such that the segment regions R1 and R2 are sequentially allocated to the plurality of tools T1 and T2. Note that the figure depicts the outlines of the two-dimensional codes C1 and C2 with thin alternate long and short dash lines, and depicts the relative movement paths (tool paths) L1 and 12 of the tools T1 and T2 with respect to the workpiece W with thick alternate long and short dash lines. In the figure, the segment regions R1 and R2 are each indicated by being surrounded by one envelope (alternate long and two short dashes line). However, the segment regions R1 and R2 may each include a plurality of isolated regions in which portions of or the entirety of the two-dimensional codes C1 and C2 are present.

The parallel process generation unit 25 is preferably configured to segment the integrated pattern P into a plurality of segment regions R1 and R2 in accordance with a dividing line D constituted by a straight line parallel to one edge of the two-dimensional codes C1 and C2. Segmenting the integrated pattern P in such a manner allows the integrated pattern P to be equally divided relatively easily.

For each of the segment regions R1 and R2, the parallel process generation unit 25 may generate a parallel process including a tool path corresponding to two or more passes. A tool path corresponding to on pass may be set such that: the same rows are machined in the segment regions R1 and R2; and a shift of one row is made outside the segment regions R1 and R2. A main movement direction of the tools T1 and T2 with respect to the workpiece W is preferably parallel to the dividing line D for segmenting the integrated pattern P. In this way, since a long distance of machining can be achieved on the tool path corresponding to one pass, the number of times the tools T1 and 12 are accelerated/decelerated is decreased, so that the machining time can be shortened.

The segment regions R1 and R2 may be set by segmenting the integrated pattern P in accordance with a preset width, but are preferably set at every opportunity in accordance with, for example, the shape of the integrated pattern P and the specifications of the tools T1 and T2 in order to enhance the efficiency of utilization of all of the tools T1 and 12. The number of segment regions R1 and R2 is preferably an integral multiple of the number of tools T1 and T2 so that an equal number of segment regions R1 and R2 can be allocated to each of the tools T1 and T2, and is more preferably equal to the number of tools T1 and T2 in order to suppress the movement distance of the tools T1 and T2.

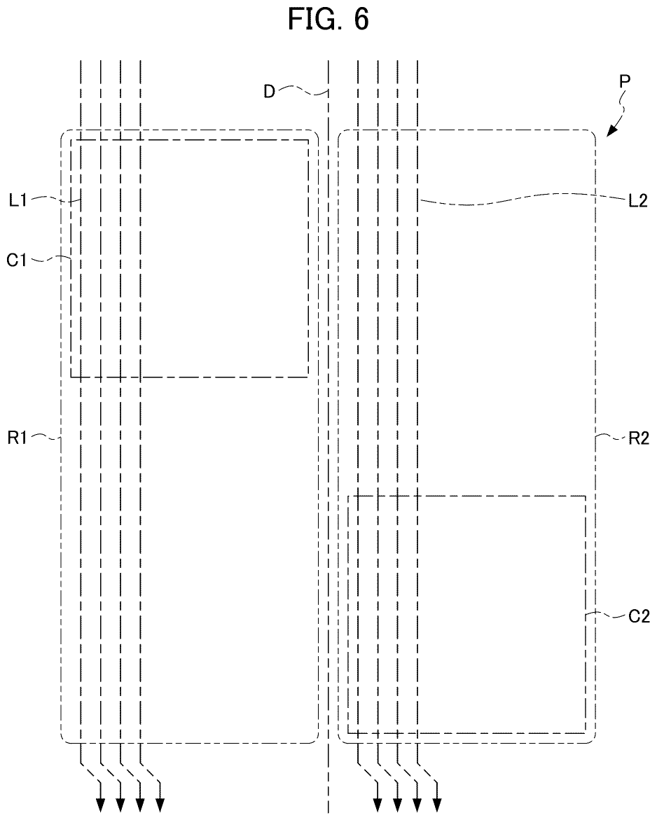

In FIG. 5, two two-dimensional codes C1 and C2 are arranged in the rotation direction of the main shaft Ac, so each of the two-dimensional codes C1 and C2 is divided into a plurality of segment regions R1 and R2 and formed by a plurality of tools T1 and T2. However, when two two-dimensional codes C1 and C2 are offset in the feed direction of tools T1 and T2 as depicted in FIG. 6, the two-dimensional codes C1 and C2 may each be formed by a single tool T1/T2.

The parallel process execution unit 26 executes, in parallel, parallel processes generated by the parallel process generation unit 25, the number of the parallel processes being equal to the number of tools T1 and T2. As a result, a plurality of two-dimensional codes C1 and C2 are formed on the surface of the workpiece W. Note that when only one tool is valid, e.g., when only the first tool T1 is valid, the parallel process execution unit 26 generates only one parallel process.

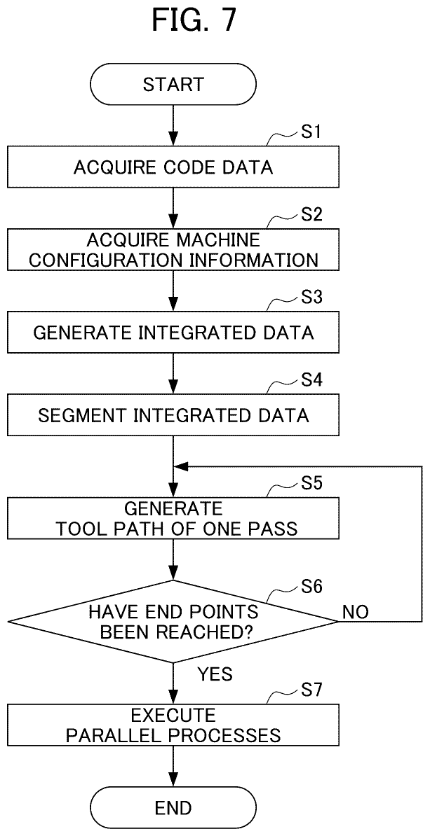

FIG. 7 illustrates a procedure with which the machine tool 1 forms two-dimensional codes C1 and C2 on a workpiece W, i.e., the procedure of a method used by the machine tool 1 to form two-dimensional codes C1 and C2.

The two-dimensional code forming method used by the machine tool 1 includes: an operation of acquiring code data (Step S1); an operation of acquiring machine configuration information (Step S2); an operation of generating integrated data (Step S3); an operation of segmenting the integrated data into segment regions (Step S4); an operation of generating a tool path of one pass for each of the segment regions (Step S5); an operation of checking whether the tool paths have reached the end points of the segment regions (Step S6); and an operation of executing parallel processes (Step S7). In this procedure, the operation of repeating Steps 85 and S6 is the operation performed by the parallel process generation unit 25 of generating parallel processes.

The machine tool 1 generates an integrated pattern P including all the two-dimensional codes C1 and C2, and then generates parallel processes in which all the valid tools T1 and T2 share the load of forming the integrated pattern P. Thus, the machine tool 1 can suppress the movement distance and the standby time of the tools T1 and T2, thereby forming the two-dimensional codes C1 and C2 efficiently in a relatively short time.

The following appendixes are further disclosed with respect to the above-described embodiments and variations.

### Appendix 1

A numerical control device (20) for controlling a machining mechanism (10) for machining a workpiece (W) by using a plurality of tools (T1, T2), the numerical control device including: a configuration information storage unit (22) that stores machine configuration information including information on the tools (T1, T2) of the machining mechanism (10); a code data acquisition unit (23) that acquires code data for identifying the shape of one or more two-dimensional codes (C1, C2) to be formed on the surface of the workpiece (W); a parallel process generation unit (25) that generates a plurality of parallel processes on the basis of the code data and the machine configuration information, the plurality of parallel processes being allocated to all of valid one or more (T1, T2) of the plurality of tools on a one-to-one basis, and being executed in parallel so as to cooperatively operate all of the valid one or more (T1, T2) of the plurality of tools such that all of the two-dimensional codes (C1, C2) are formed; and a parallel process execution unit (26) that executes the parallel processes.

### Appendix 2

A numerical control device (20) for controlling a machining mechanism (10) for machining a workpiece (W) by using a tool (Il), the numerical control device including: a configuration information storage unit (22) that stores machine configuration information including information on the tool (T1) of the machining mechanism (10); a code data acquisition unit (23) that acquires code data for identifying the shape of a plurality of two-dimensional codes (C1, C2) to be formed on the surface of the workpiece (W); a parallel process generation unit (25) that generates a parallel process on the basis of the code data and the machine configuration information, the parallel process being for operating the tool (T1) such that all of the two-dimensional codes (C1, C2) are formed in parallel; and a parallel process execution unit (26) that executes the parallel process.

### Appendix 3

A numerical control device (20) for controlling a machining mechanism (10) for machining a workpiece (W) by using one or a plurality of tools (T1, T2), the numerical control device including: a configuration information storage unit (22) that stores machine configuration information including information on the tools (T1, T2) of the machining mechanism; a code data acquisition unit (23) that acquires code data for identifying the shape of one or more two-dimensional codes (C1, C2) to be formed on the surface of the workpiece (W); an integrated-data generation unit (24) that generates integrated data for identifying the shape of a single integrated pattern (P) including all the two-dimensional codes (C1, C2); a parallel process generation unit (25) that generates a plurality of parallel processes on the basis of the integrated data and the machine configuration information, the plurality of parallel processes being allocated to all of valid one or more (T1, T2) of the one or plurality of tools on a one-to-one basis and being executed in parallel so as to cooperatively operate all of the valid one or more (T1, T2) of the one or plurality of tools such that all of the two-dimensional codes (C1, C2) are formed; and a parallel process execution unit (26) that executes the parallel processes.

### Appendix 4

The parallel process generation unit (25) may segment the integrated pattern (P) into a plurality of segment regions (R1, R2) having an equal width, and generate parallel processes such that the segment regions (R1 and R2) are sequentially allocated to the plurality of tools (T1, T2).

### Appendix 5

The parallel process generation unit (25) may segment the integrated pattern (P) into a plurality of segment regions (R1, R2) in accordance with a straight line (D) parallel to one edge of the two-dimensional codes (C1, C2).

### Appendix 6

The parallel process generation unit (25) may generate the parallel processes, in which a direction parallel to the straight line (D) for segmenting the integrated pattern (P) is the main movement direction of the one or plurality of tools (T1, T2) with respect to the workpiece (W).

### Appendix 7

The machine configuration information may include the number of valid one or more (T1, T2) of the tools.

### Appendix 8

A machine tool (1) includes the numerical control device (20) according to any of appendixes 1 to 7, and a machining mechanism (10) that is controlled by the numerical control device (20).

Although the present disclosure has been described in detail, the present disclosure is not limited to the individual embodiments described above. These embodiments can have various features added thereto, can have various features replaced with those therein, can have various changes made therein, and can be subjected to partial deletion without departing from the gist of the present disclosure that is derived from the details set forth in the claims and equivalents of the details. These embodiments may also be implemented in combination with each other. In the embodiments described above, for example, the orders in which operations or processes are performed are indicated as examples, and the present invention is not limited to such orders. This is also true of any numerical values and numerical equations or expressions referred to with respect to the embodiments described above.

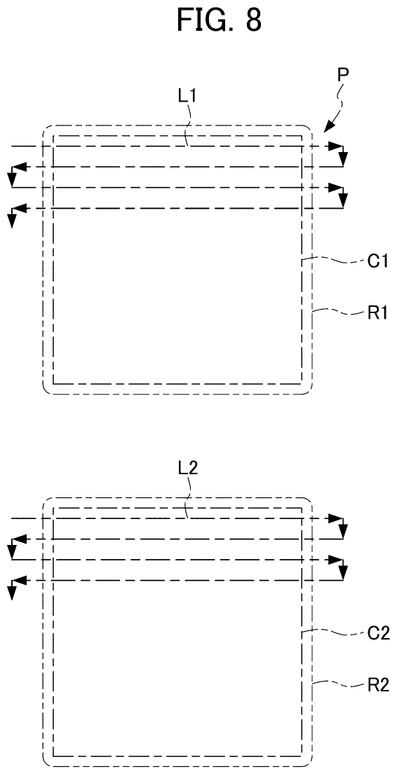

According to the machine tool of the present disclosure, the machining mechanism may perform types of machining, e. g., fraise machining, laser machining, in addition to turning. According to the machine tool of the present disclosure, a dividing direction for the integrated pattern may be appropriately selected according to, for example, the type of machining and/or the axial configuration of the machining mechanism. As exemplified in FIG. 8, as an example, when the surface of the workpiece is scanned while the tool is reciprocating, the integrated pattern is preferably segmented into a plurality of segment regions in the sub-scanning direction. In the case of a combined lathe capable of milling the surface of a workpiece that can be positioned by being rotated by a main shaft, the main scanning direction is the feed direction of the tool, and the movement of the tool in the sub-scanning direction with respect to the workpiece may be achieved by the workpiece being turned forwardly or rearwardly.

### EXPLANATION OF REFERENCE NUMERALS

1: Machine tool
10: Machining mechanism
20: Numerical control device
21: Machining control unit
22: Configuration information storage unit
23: Code data acquisition unit
24: Integrated-data generation unit
25: Parallel process generation unit
26: Parallel process execution unit
Ac, Ax1, Ax2, Az1, Az2: Drive shaft, main shaft
C1, C2: Two-dimensional code
D: Dividing line
L1, L2: Tool path
P: Integrated pattern
R1, R2: Segment region
T1, T2: Tool
W: Workpiece

1. A numerical control device for controlling a machining mechanism for machining a workpiece by using a plurality of tools, the numerical control device comprising:
a configuration information storage unit that stores machine configuration information including information on the plurality of tools of the machining mechanism;
a code data acquisition unit that acquires code data for identifying a shape of one or more two-dimensional codes to be formed on a surface of the workpiece;
a parallel process generation unit that generates a plurality of parallel processes on a basis of the code data and the machine configuration information, the plurality of parallel processes being allocated to all of valid one or more of the plurality of tools on a one-to-one basis, and being executed in parallel so as to cooperatively operate all of the valid one or more of the plurality of tools such that all of the two-dimensional codes are formed; and
a parallel process execution unit that executes the parallel processes.

2. A numerical control device for controlling a machining mechanism for machining a workpiece by using a tool, the numerical control device comprising:
a configuration information storage unit that stores machine configuration information including information on the tool of the machining mechanism;
a code data acquisition unit that acquires code data for identifying a shape of a plurality of two-dimensional codes to be formed on a surface of the workpiece;
a parallel process generation unit that generates a parallel process on a basis of the code data and the machine configuration information, the parallel process being for operating the tool such that all of the two-dimensional codes are formed in parallel; and
a parallel process execution unit that executes the parallel process.

3. A numerical control device for controlling a machining mechanism for machining a workpiece by using one or a plurality of tools, the numerical control device comprising:
a configuration information storage unit that stores machine configuration information including information on the tools of the machining mechanism;
a code data acquisition unit that acquires code data for identifying a shape of one or more two-dimensional codes to be formed on a surface of the workpiece;
an integrated-data generation unit that generates integrated data for identifying a shape of a single integrated pattern including all of the two-dimensional codes;
a parallel process generation unit that generates a plurality of parallel processes on a basis of the integrated data and the machine configuration information, the plurality of parallel processes being allocated to all of valid one or more of the one or plurality of tools on a one-to-one basis, and being executed in parallel so as to cooperatively operate all of the valid one or more of the one or plurality of tools such that all of the two-dimensional codes are formed; and
a parallel process execution unit that executes the parallel processes.

4. The numerical control device according to claim 3, wherein
the parallel process generation unit segments the integrated pattern into a plurality of segment regions having an equal width, and generates the parallel processes such that the segment regions are sequentially allocated to the plurality of tools.

5. The numerical control device according to claim 3, wherein
the parallel process generation unit segments the integrated pattern into a plurality of segment regions in accordance with a straight line parallel to one edge of the two-dimensional codes.

6. The numerical control device according to claim 5, wherein
the parallel process generation unit generates the parallel processes, in which a direction parallel to the straight line for segmenting the integrated pattern is a main movement direction of the one or plurality of tools with respect to the workpiece.

7. The numerical control device according to claim 1, wherein
the machine configuration information includes a number of the valid one or more of the tools.

8. A machine tool comprising:
the numerical control device according to claim 1; and
a machining mechanism that is controlled by the numerical control device.
